(19) United States
(12) Patent Application Publication
(10) Pub. No.: US 2007/0163931 A1
(43) Pub. Date: Jul. 19, 2007

(54) Plastic relief valve housing with anti-drain back valve

(75) Inventor: L. Steven Cline, Fayetteville, NC (US)

Correspondence Address: CROWELL & MORING LLP;INTELLECTUAL PROPERTY GROUP, P.O. BOX 14300, WASHINGTON, DC, 20044-4300, US

(73) Assignee: Arvin Technologies, Inc.

(21) Appl. No.: 11/334,125

(22) Filed: Jan. 18, 2006

(51) Int. Cl. B01D 35/14

(52) U.S. Cl. 210/130; 210/136; 210/420; 210/433.1

(57) ABSTRACT

A filter includes a filter housing having a tapping plate providing an inlet. A filter element assembly is arranged in the housing and includes an end disc. A bypass valve housing is arranged between the end disc and the tapping plate and supports a bypass valve. The bypass valve housing provides a cavity in fluid communication with the bypass valve. An anti-drain back valve is retained between the bypass valve housing and end disc. The inlet is in fluid communication with the cavity when the anti-drain back valve is in a closed position. The anti-drain back valve is over-molded to the bypass valve housing. The bypass valve housing including first and second portions secured to one another, for example, by ultrasonic welding. The first portion provides a spring seat, and the second portion includes first, second and third walls generally concentric with one another. The first and second walls provide a cavity, and the second wall is arranged between the first and third walls. The second wall includes apertures in communication with the cavity. A bypass valve is arranged between the first and second portions and in communication with the cavity. An anti-drain back valve is supported by a flange extending from the third wall.

### BACKGROUND OF THE INVENTION

This invention relates to a plastic relief valve housing for a filter, such as an oil filter.

Filters, such as an oil filter, include a housing providing a cavity with a filter element assembly arranged within the cavity. Valves are typically used within the filter to regulate the flow of fluid through the filter element assembly. In one example, a relief valve is used to permit fluid within the filter to bypass the filter element assembly when the fluid is very viscous, for example, during cold start conditions of an engine.

In one prior art relief valve, a two-piece metallic relief valve housing is arranged between an end disc of the filter element assembly and a tapping plate of the housing. One portion of the relief valve housing includes a pair of concentric annular walls that provide a cavity in communication with the relief valve. Under a predetermined pressure, fluid within the cavity opens the relief valve.

An anti-drain back valve is arranged between the one portion of the relief valve housing and the tapping plate. However, when the fluid is very viscous, the anti-drain back valve may become stuck between the relief valve housing and the end disc thereby blocking fluid flow into the cavity. As a result, the very viscous fluid is not permitted to bypass the filter element assembly as needed. To this end, a metallic backing plate is arranged between the anti-drain back valve and the relief valve housing to limit the travel of the anti-drain back valve.

What is needed is a relief valve housing that eliminates the need for the backing plate. Furthermore, it is desirable to minimize the use of metal within a filter to improve the recyclability of the filter.

### SUMMARY OF THE INVENTION

A filter includes a filter housing having a tapping plate providing an inlet. A filter element assembly is arranged in the housing and includes an end disc. A bypass valve housing is arranged between the end disc and the tapping plate and supports a bypass valve. The bypass valve housing provides a cavity in fluid communication with the bypass valve. An anti-drain back valve is retained between the bypass valve housing and end disc. The inlet is in fluid communication with the cavity when the anti-drain back valve is in a closed position. The anti-drain back valve is over-molded to the bypass valve housing. The bypass valve housing including first and second portions secured to one another, for example, by ultrasonic welding. The first portion provides a spring seat, and the second portion includes first, second and third walls generally concentric with one another. The first and second walls provide a cavity, and the second wall is arranged between the first and third walls. The second wall includes apertures in communication with the cavity. A bypass valve is arranged between the first and second portions and in communication with the cavity. An anti-drain back valve is supported by a flange extending from the third wall.

These and other features of the present invention can be best understood from the following specification and drawings, the following of which is a brief description.

### BRIEF DESCRIPTION OF THE DRAWINGS

FIG. 1 is a cross-sectional view of a filter with the inventive plastic relief valve housing.

FIG. 2 is a perspective view of the relief valve housing shown in FIG. 1.

FIG. 3A is a perspective view of one portion of the relief valve housing shown in FIG. 1 along with the anti-drain back valve.

FIG. 3B is a side elevational view of the one portion of the relief valve housing shown in FIG. 3A.

FIG. 3C is a cross-sectional view of the one portion of the relief valve housing shown in FIG. 3B.

FIG. 4 is a perspective view of a relief valve shown in FIG. 1.

### DETAILED DESCRIPTION OF THE PREFERRED EMBODIMENT

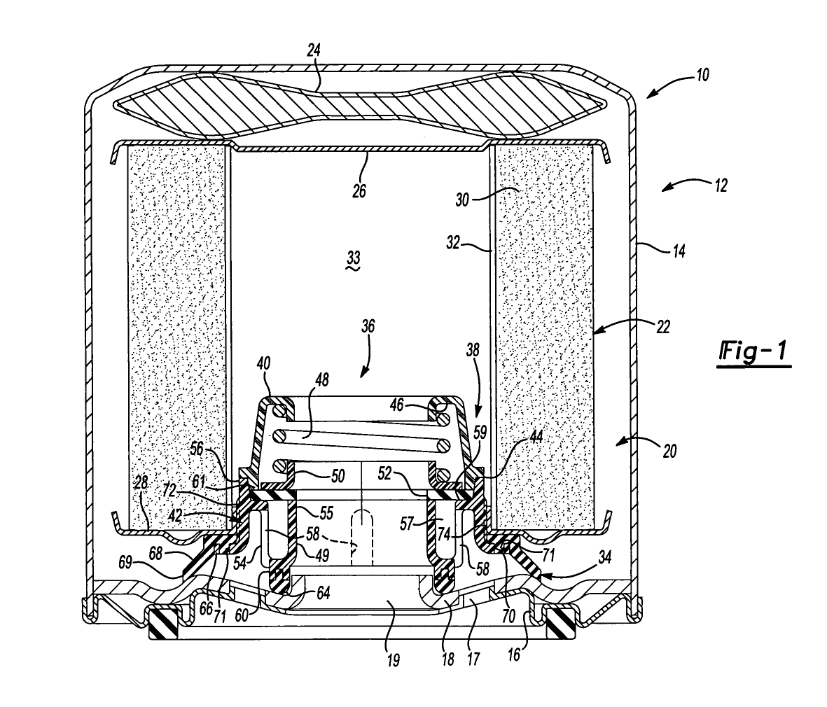

A filter 10 is shown in FIG. 1. The filter 10 is used as an oil filter, and includes a housing 12. The housing 12 includes a can 14 providing a cavity 20 that is enclosed by a retainer 16. The retainer 16 supports a tapping plate 18. The retainer 16 and tapping plate 18 provide an inlet 17 that includes multiple holes and an outlet 19. The outlet 19 is provided by a threaded aperture that is used to secure the filter 10 to an engine mounting block using a mounting stud (not shown).

A filter element assembly 22 is arranged within the cavity 20 to filter debris from a fluid passing through the filter 10. The filter element assembly 22 includes a filter media 30 arranged between an end cap 26 and an end disc 28. An element guide 24 biases the filter element assembly 22 toward the tapping plate 18 to ensure a good seal about the filter element assembly 22 so that the fluid is forced to go through the filter element assembly 22.

The filter media 30 provides a central opening 33 that is supported by a center tube 32 arranged between the end cap 26 and end disc 28. An anti-drain back valve 34 is provided between the filter element assembly 22 and the tapping plate 18 to prevent back flow of fluid that has entered the filter 10. A bypass valve 36 is used to permit viscous fluid to bypass the filter element assembly 22 during some conditions.

The bypass valve 36 includes an inventive housing 38 that is constructed from a suitable plastic. Typically, the housing 38 must accommodate the diameter of the mounting stud. The housing 38 includes first and second portions 40 and 42 that are secured at a joint 44, for example, by ultrasonic welding. The two-piece housing 38 facilitates assembly of the bypass valve 36.

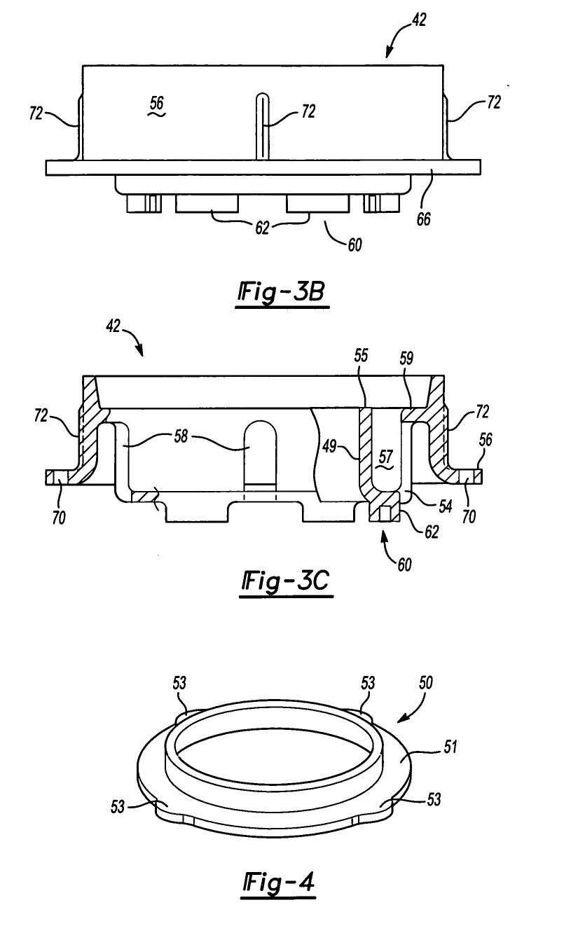

The first portion 40 provides a fixed seat 46 for a spring 48, such as a coil spring. The spring 48 urges a movable seat 50 into engagement with a valve 52 that is supported by the second portion 42. The valve 52 is constructed from a flexible material. The movable seat 50 includes an annular wall 51 having ears 53 that ride along an interior surface of the first portion 40 to reduce the friction between the movable seat 50 and first portion 40, best shown in FIGS. 1 and 4.

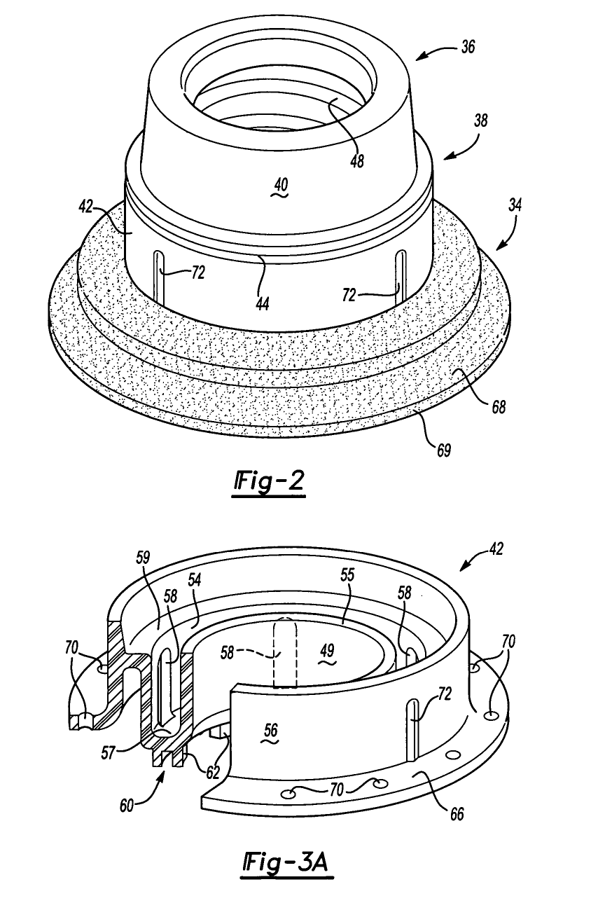

An outer periphery of the valve 52 is retained between a shoulder 59 of the first portion 40 and an end 61 of the second portion 42. The second portion 42 includes generally concentric first, second and third walls 49, 54 and 56. The first, second and third walls 49, 54 and 56 are arranged to provide a generally annular structure having an S-shaped cross-section. An inner periphery of the valve 52 seals against an end 55 of the third wall 56 when the bypass valve 36 is in the closed position (shown in FIG. 1). An outer surface of the third wall 56 includes ridges 72, best shown in FIG. 2, that are used to locate the second portion 42 relative to an inner periphery 74 of the end disc 28.

Referring to FIGS. 1 and 3A-3C, an annular flange 66 extends radially from the third wall 56. The annular flange 66 includes multiple holes 70. A valve 68, which provides the anti-drain back feature, is over-molded onto the flange 66 so that protrusions 71 of the valve 68 extend into the holes 70. The valve 68 is retained between the annular flange 66 and the end disc 28. An annular lip 69 seals against the tapping plate 18 when the anti-drain back valve 34 is in the closed position (shown in FIG. 1).

The second wall 54 includes multiple apertures 58 that fluidly connect the inlet 17 to a cavity 57 arranged between the first and second walls 49 and 54. A very viscous fluid reaching a predetermined pressure within the cavity 57 will overcome the biasing force provided by the spring 48 thereby moving the valve 52 away from the end 55. With the valve 52 in this open position, fluid is permitted to bypass the filter element assembly 22 and flow directly from the inlet 17 to the outlet 19. During filter use, the anti-drain back valve 34 deflects out of engagement with the tapping plate 18 toward the end disc 28. Notably, the anti-drain back valve 34 will not block flow of fluid into the cavity 57 when fully deflected. Further, the inlet 17 and cavity 57 are in direct fluid connection under all operating conditions.

The first and second walls 49 and 54 join at an end 60 that provides multiple projections 62. A seal 64 (shown in FIG. 1) is over-molded onto the end 60 and secured to the projections 62 to provide a seal between the second portion 42 and the tapping plate 18. The seal 64 and valves 52 and 68 may, for example, be made from any suitable elastomeric material having a desired durometer for the particular application.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A filter comprising:
a filter housing including a tapping plate providing an inlet;
a filter element assembly arranged in the filter housing and having an end disc;
a bypass valve housing arranged between the end disc and the tapping plate, the bypass valve housing supporting a bypass valve and providing a cavity in fluid communication with the bypass valve; and
an anti-drain back valve retained between the bypass valve housing and end the disc, the inlet in fluid communication with the cavity when the anti-drain back valve is in a closed position.

2. The filter according to claim 1, wherein the anti-drain back valve includes an annular lip in engagement with the tapping plate in the closed position.

3. The filter according to claim 1, wherein the bypass valve housing includes first and second portions secured to one another, the second portion providing the cavity, the second portion including first, second and third walls spaced radially from one another, and the second and third walls defining the cavity, the bypass valve sealing an open end of the cavity when in a closed bypass position.

4. The filter according to claim 3, wherein the third wall supports the anti-drain back valve.

5. The filter according to claim 3, wherein the second wall includes apertures, the second wall arranged between the first and third walls.

6. The filter according to claim 1, wherein a seal is supported by the bypass valve housing and is spaced from the anti-drain back valve and the bypass valve, the seal in engagement with the tapping plate.

7. The filter according to claim 6, wherein the seal is arranged between the inlet and an outlet provided by the tapping plate.

8. The filter according to claim 1, wherein the bypass valve housing includes holes and the anti-drain back valve includes protrusions extending through said holes interlocking the anti-drain back valve to the bypass valve housing.

9. A bypass valve for use in a filter comprising:
a housing including first and second portions secured to one another, the first portion providing a spring seat, and the second portion including first, second and third walls generally radially spaced from one another, the first and second walls providing a cavity, the second wall arranged between the first and third walls and including apertures in communication with the cavity;
a bypass valve arranged between the first and second portions and in communication with the cavity; and
an anti-drain back valve supported by a flange extending from the third wall.

10. The bypass valve according to claim 9, wherein the first and second portions are formed from plastic.

11. The bypass valve according to claim 9, wherein the bypass valve is retained between the first and second portions.

12. The bypass valve according to claim 9, wherein the bypass valve seals against an end of the first wall in a closed position.

13. The bypass valve according to claim 12, wherein a movable seat is arranged within the first portion, and a spring arranged between the spring seat and the movable seat urging the bypass valve to the closed position.

14. The bypass valve according to claim 12, wherein the movable seat includes spaced apart ears extending radially outwardly into engagement with an interior surface of the first portion for sliding engagement with the interior surface.

15. A method of assembly a bypass valve housing comprising the steps of:
a) providing first and second housing portions;
b) arranging a bypass valve between the first and second housing portions;
c) securing the first and second housing portions to one another; and
d) installing the bypass valve housing into a filter subsequent to performing step c).

16. The method according to claim 15, wherein the first and second housing portions are formed from plastic.

17. The method according to claim 16, wherein step c) includes ultrasonically welding the first and second housing portions to one another.

18. The method according to claim 16, comprising the step of over-molding an anti-drain back valve onto the second housing portion prior to performing step d).

19. The method according to claim 18, comprising the step of over-molding a seal onto the second housing portion prior to performing step d).

20. The method according to claim 18, wherein the second housing portion includes holes and the over-molding step provides projections extending from the anti-drain back valve received in the holes.
